(19) United States
(12) Patent Application Publication
(10) Pub. No.: US 2025/0237055 A1
(43) Pub. Date: Jul. 24, 2025

(54) ACOUSTIC ROOM WITH ABSORPTION AND REFLECTION (DIFFUSION/SCATTERING) BALANCING SYSTEM

(71) Applicant: Roshan George THOMAS, Chennai (IN)

(72) Inventor: Roshan George THOMAS, Chennai (IN)

(21) Appl. No.: 18/852,853

(22) PCT Filed: Feb. 18, 2023
(86) PCT No.: PCT/IB2023/051494

§ 371 Date: Sep. 30, 2024

(30) Foreign Application Priority Data
Apr. 1, 2022 (IN) 2022410 19844

(51) Int. Cl. E04B 1/99

(52) U.S. Cl. CPC E04B 1/99

(57) ABSTRACT

Acoustic room with absorption and reflection (diffusion/scattering) balancing system. The system (100) comprises an absorption component (110) to absorb of the low frequency range in a sound within the room/environment (160). A reflection component (150) that serves as “psychoacoustic localization waypoints” and add reflections that naturalize the environment (140) to the auditory system.

### CROSS REFERENCE TO RELATED APPLICATIONS

This is a National Phase application of PCT/IB2023/051494, filed Feb. 18, 2023, which relies for priority on Indian Application Serial No. 2022410 19844 filed on Apr. 1, 2022, is now pending, the entire specification of which is incorporated by reference as if fully set forth herein.

### BACKGROUND OF THE INVENTION

### 1. Technical Field

The present invention generally relates to acoustics and sound management systems and methods. The present invention also relates to systems and methods for improving the quality of sound generated by sound sources (low frequency) in room/environment. Further, the invention relates to mechanism to achieve the balance between the absorption and reflection (diffusion/scattering) to balance the sound experience in a room/environment. The invention additionally relates to acoustic rooms/environments for a wide range of professional applications. Further, the present invention specifically relates to an acoustic room with absorption and reflection (diffusion/scattering) balancing system for achieving an ideal balance between absorption and reflection of sound in an acoustic room/environment.

### 2. Background Art

Sound systems that transform electrical signals into acoustic signals are well-known in the art. Such sound systems may include one or more transducers that produce a range of acoustic signals, such as high, mid, and low-frequency signals. An example, a loudspeaker with a subwoofer may comprise a low frequency transducer that typically produces low-frequency signals in the range of 20 Hz to 100 Hz.

The sound systems may generate the acoustic signals in a variety of listening environments, such as, home listening rooms, home theaters, movie theaters, concert halls, vehicle interiors, and recording studios. Each of the above-mentioned environments may affect the acoustic signals, including the low, mid and high frequency signals. Depending on the acoustic characteristics of the room/environment, the position of the listener in a room and the position of the loudspeaker in the room, the loudness of the sound can vary for different frequencies. This may be especially true for low frequencies.

It is relatively easy to install passive dampening systems made of fiber material to adequately absorb frequencies above 500 Hz approximately. However, these passive absorbers are not suitable for lower frequencies as the necessary thickness of material increases with the wavelength. As an example, a minimum thickness of 1 m of material is necessary to suitably absorb frequencies of 100 Hz. In a standard sized room, the natural standing resonance frequencies are in general relatively low and therefore represent a serious problem to be controlled.

Low frequencies may be important to the enjoyment of music, movies, and other forms of audio entertainment. For example, in a recording studio, the room boundaries, including the walls, draperies, furniture, furnishings, and the like, may affect the acoustic signals as they travel from the loudspeakers to the listening positions. Furthermore, the premises used for sound measurement, recording, production, rehearsals, foley, and performances, such as recording or postproduction studios, concert halls, sound laboratories, etc. need to be acoustically treated to obtain the adequate reverberation and echo that is required for their use.

The sound produced (for example, by a studio monitoring system or a home theatre system) inside a room leads to generation of modal resonances which particularly affect the perception of low frequencies of sound and are harder to control in smaller rooms. When a closed room is employed for critical listening, the nature of the room in which the sound energy is produced influences the quality of sound perceived by the listener. The nature of the boundary surfaces (walls, floors and ceiling) and the dimensions of the room critically affect the quality of sound in the room. The boundaries act as reflective surfaces and the representation of the music perceived by the listener is “coloured/smeared” such that it is not an authentic representation of the sound produced by the music system.

The reverb of the room, and other significant acoustic phenomena like flutter echoes, modal resonances and comb-filtering which are undesirable and substantially change the authenticity of the sound being reproduced by a speaker system compared to how it was recorded and edited during its creation. Hence a need arises to create a listening environment that is neutral in its acoustic signature and void of all possible means by which the quality of sound perceived during playback is tarnished in any way, and thereby the listening experience be pleasant and the sonic identity and frequential authenticity of the song be retained during its reproduction. Therefore, a need exists for an acoustic solution for a closed space designated for listening with acoustic solutions that target the undesirable acoustic phenomena that degrade the quality of sound perceived in the space.

Systems and methods for managing the acoustics in a room/environment, especially in the applications for critical listening (such as studios engaging in music recording, music production, audiophile spaces, sound-testing laboratories, etc.), can be broadly categorized into “absorption” and “diffusion” and vary in terms of complexity depending on the region of the frequency spectrum taken into consideration.

With the increase in real estate costs, the sizes of studios are becoming smaller and an increase in demand for high quality and precision acoustic solutions for small rooms has risen. This has led to a need for an effective solution to handle and control low frequencies influenced by the principles of wave acoustics, but also comprehensively address the entire audible and experienced frequency range beyond the currently accepted limits of 20 Hz to 20,000 Hz.

To address the problems associated with the prior arts, the applicant of this patent has filed a patent (patent application No. 202241009271) on a low frequency acoustic room and environment ideal for managing and controlling low frequency sounds for a wide range of professional applications which teaches an inner wall portion comprising a plurality of porous-but-resistive membranes operatively configured along the wall portions of the inner wall portion wherein the porous-but-resistive membranes shares a communicating space with a volume of air behind the inner wall portion. An outer wall portion covering the inner wall portion wherein the outer wall portion is to create the communicating space wherein the inner volume of air communicates with the volume of air in the communicating space via the porous-but-resistive membranes and thereby effectively absorb and control the low frequencies influenced by the principles of the wave acoustics generated in the room/environment and provide a comprehensive audible and experienced frequency range suitable for a wide range of professional purposes.

However, the requirement for achieving an ideal balance between the absorption and reflection of the sound in the room/environment is not addressed in the prior arts and there is a need for addressing the absorption and reflection balance in sound in a room to provide an effective sound experience for a user in a acoustic room/environment.

Based on the foregoing, it is believed that a need exists for an improved acoustic room/environment with an ideal balance between absorption and reflection. Also, a need exists for an acoustic room with absorption and reflection (diffusion/scattering) balancing system for achieving an ideal balance between absorption and reflection of sound in an acoustic room/environment, as described in greater detail herein.

### SUMMARY OF THE INVENTION

The following summary is provided to facilitate an understanding of some of the innovative features unique to the disclosed embodiment and is not intended to be a full description. It is, therefore, one aspect of the disclosed embodiments to provide for an improved acoustic room/environment ideal for managing and controlling low frequency range. It is another aspect of the disclosed embodiments to provide for an improved ideal balancing system for managing the absorption and reflection aspects of sound in a room/environment.

It is further aspect of the disclosed embodiments to provide for an improved an acoustic room with absorption and reflection (diffusion/scattering) balancing system for achieving an ideal balance between absorption and reflection of sound in an acoustic room/environment.

The aforementioned aspects and other objectives and advantages can now be achieved as described herein. Acoustic room with absorption and reflection (diffusion/scattering) balancing system, is disclosed herein. The system (100) comprises an absorption component (110) to absorb of the low frequency range in a sound within the room/environment (160). A reflection component (150) that serves as “psychoacoustic localization waypoints” and add reflections that naturalize the environment (140) to the auditory system.

The absorption component (110) comprising of an outer non-porous rigid wall member (120) and an inner porous but resistive wall member (130) with a gap between the outer non-porous rigid wall member (120) and the inner porous but resistive wall member (130) which helps in effective absorption of low frequency range in a sound within the room/environment (140).

The reflection component (150) comprising an array of plate members (160) that are operatively configured within the inner wall portion of the inner porous but resistive wall member (130) wherein the plate members (160) serve as “psychoacoustic localization waypoints” and add reflections that naturalize the environment (140) to the auditory system. The reflection component (150) may be further modified by modifying the plate member (160) as diffusive elements, scattering elements (to achieve different kinds of reflections), or even porous absorber-based elements. The nature of the plate members of the reflection component can also be modified in terms of material, directivity or exclusion (for example removing plate members at first reflection points related to a listening position or for other acoustic goals).

The gap (170) between the outer non-porous rigid wall member (120) and the inner porous but resistive wall member (130) must create a sufficiently large volume between the walls (120 and 130) that allows for the pressure differential created on the inner side of the porous but resistive membrane to push a sufficient volume of air through to the other side. As air is pushed through, pressure reduces until equalized, so does the modal influences, with assistance in attenuation by the thermal losses when propagating though the resistive material, and the degree of attenuation is designed such that lowest modal fundamental resonant frequencies to effectively attenuated to set standards within internationally.

Further, to create the most amount of floor space inside the inner room, which is desirable, (the room within the inner shell consisting of the porous but resistive membrane), this gap can be equated to at least between 35% to 82% of the distance from the outer rigid wall member (120) to the 1st PEAK/ANTINODE of that multiple of the axial mode's fundamental frequency that crosses the Schroeder frequency along that dimension of the room's boundary. This ensures that all modal influences of the fundamental and its multiples share a strong influence of their pressure component acting on the porous but resistive membrane in that position. It is important to note that as the low frequencies are harder to treat when compared the mid and high frequencies, this Absorptive component has an added benefit, that it also executes mid and high frequency absorption, thereby providing Full Spectrum Absorption effectively.

Alternatively, in exceptional cases where either the dimensions of the room or the additional bass loading on the room can increases the intensity of the resonances, and although the efficiency of the system (100) would still be enough to attenuate low frequency response effectively, greater low frequency attenuation in the sub bass (below 60 Hz) frequency region for unique cases of monitoring systems with increased low frequency reproduction can be achieved by introducing a middle non-porous rigid wall with gaps in the bicorners, as shown in FIG. 2. This variation in the design allows for the boundary surface to create the resonant pressure (non-porous middle wall), which the porous-but-resistive membrane innermost porous wall takes advantage off and allows air flow through it till pressure is equalized, and the gap volume to be maximised by the middle wall's gaps-in-the-corners increasing the entire volume of the air space behind the innermost porous-but resistive membrane shell. It is important to note that the operative gap size as defined earlier, is in this circumstance measured from the middle rigid non-porous wall member to the inner porous-but resistive wall member. The gap size between the middle and outer walls could be variable according to design needs.

In an alternative embodiment of the present invention, as shown in FIG. 3, the absorption component (110) comprising of an outer non-porous rigid wall member (120) that is configured with a layer of resistive member (130) and an inner porous but resistive wall member (130) with a gap between the outer non-porous rigid wall member (120) and the inner porous but resistive wall member (130) which helps in effective absorption of low frequency range in a sound within the room/environment (140).

The additional bass loading on the room can increase the intensity of the resonances of the, and although the efficiency of the system (100) would still be enough to attenuate low frequency response effectively, greater low frequency attenuation in the sub bass (below 60 Hz) frequency region for unique cases of monitoring systems with increased low frequency reproduction can be achieved by introducing a middle non-porous rigid wall member (210) that is configured with a porous member (130) with gaps in the bicorners, as shown in FIG. 3.

### BRIEF DESCRIPTION OF THE DRAWINGS

FIG. 1 illustrates a plan view of the absorption and reflection (diffusion/scattering) balancing system;

FIG. 2 illustrates a plan view of an acoustic room having an absorption and reflection balancing system (100) with a middle non-porous rigid wall member with gaps in the bicorners, in accordance with the disclosed embodiment;

FIG. 3 illustrates a plan view of an alternative embodiment of an acoustic room having an absorption and reflection balancing system according to the present invention; and

FIGS. 4-7 illustrates in photographic form the GUIs of the measured frequencies of an acoustic room according to the present invention.

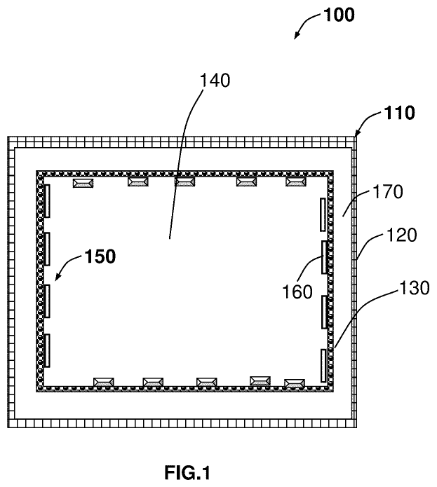

### DETAILED DESCRIPTION OF THE PREFERRED EMBODIMENTS

The values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Description of the Invention: Acoustic room with absorption and reflection balancing system, is disclosed herein. The system (100) comprises an absorption component (110) to absorb the low frequency range in a sound within the room/environment (160). A reflection component (150) that serves as “psychoacoustic localization waypoints” and add reflections that naturalize the environment (140) to the auditory system.

The absorption component (110) comprising of an outer non-porous rigid wall member (120) and an inner porous but resistive wall member (130) with a gap (170) between the outer non-porous rigid wall member (120) and the inner porous but resistive wall member (130) which helps in effective absorption of low frequency range in a sound within the room/environment (140).

Working of the absorption component (110): The inner porous but resistive membrane (130) may be comprised of 1 or more materials but has defined characteristics relating to its gap from the outer wall, thickness, gas flow resistivity and permeability that is related to the size of the room comprised of the rigid nonporous outer wall and its modal characteristics. The method in which the variables are selected are as follows:

The reverberation time (T, in seconds) of the outer room is measured to calculate the Schroeder frequency—Fs=2000·(T/V)^{0.5} when volume is in meters, and 11885·(T/V)^{0.5} when volume is in feet.

A room of 16×14×10 ft was used as the test room: the volume V is 2240 cu. Ft. The RT 60 measured when the room was empty was 3.798 s

Hence Schroeder frequency=489

To calculate the modes associated with the room's dimension, the equation below is used:

$$f = ( \frac{c}{2} ) \sqrt{{( \frac{p}{L} )}^{2} + {( \frac{q}{W} )}^{2} + {( \frac{r}{H} )}^{2}}$$

c=speed of sound (1125 ft/s)
p,q,r=modal multiples of the fundamental
L, W, H=dimensions of length, width, and height

The first multiples of the fundamental axial modal frequencies to cross the Schroeder frequency (SF) is calculated for each dimension. For the L dimension (16 ft), the fundamental modal frequency is 35.17, and the first multiple of it to cross SF (489 Hz) is the 14^{th} multiple (35.17×14=492.38 Hz). For the W dimension (14 ft), the fundamental modal frequency is 40.19, and the first multiple of it to cross SF (489 Hz) is the 13^{th} multiple (40.19×13=522.5 Hz). For the H dimension (10 ft), fundamental modal frequency is 56.27, and the first multiple of it to cross SF (489 Hz) is the 9^{th} multiple (56.27×9=506.5 Hz).

To determine the gap of the inner porous-but-resistive membrane from the outer wall alone, two conditions must be met. The gap between the outer nonporous rigid wall and inner porous but resistive wall must create a sufficiently large volume between the walls that allows for the pressure differential created on the inner side of the porous but resistive membrane to push a sufficient volume of air through to the other side. As air is pushed through, pressure reduces until equalized, so does the modal influences, and the degree of attenuation is designed such that lowest modal fundamental resonant frequencies are effectively attenuated to set standards within internationally.

For the goal of creating the most amount of space inside the inner room-which is desirable-(the inner room being the room within the inner shell consisting of the porous but resistive membrane), this gap can be equated to preferably between 35% to 82% of the distance from the outer rigid wall to the 1^{st} PEAK/ANTINODE point of that multiple of the axial mode's fundamental frequency that crosses the Schroeder frequency, along that dimension of the room's boundary. This ensures that all modal influences of the fundamental and its multiples share a strong influence of their pressure component acting on the porous but resistive membrane. It is important to note that as the low frequencies are harder to treat when compared the mid and high frequencies, this absorptive component (110) has an added benefit, that it also executes mid and high frequency absorption, thereby providing Full Spectrum Absorption effectively.

The reflection component (150) comprising an array of plate members (160) that are operatively configured within the inner wall portion of the inner porous but resistive wall member (130) wherein the plate members (160) serve as “psychoacoustic localization waypoints” and add reflections that naturalize the environment (140) to the auditory system. The reflection component (150) may be further modified by modifying the plate member (160) as diffusive elements, scattering elements (to achieve different kinds of reflections), or even porous absorber-based elements.

The plate members (160) that are arrayed on the boundary surfaces (of the inner porous-but resistive membrane) have defined positions and have varying sizes that related to the dimensions inner shell. The positions of the plate members are calculated such that they are located on the regions dominated by nodes/points of null pressure on the porous-but resistive membrane.

The positions allow the “plate members” to provide reflections and naturalise the room, with a minimal reduction to the efficiency of the absorptive component (a slight decrease of the efficiency of the absorptive component will be observed as the plate members after all choke the flow of air through the resistive membrane, and due to the complex behaviour of modal resonances at various points along the boundaries, this results in some points of pressure being choked to air flow, and thereby causing a slight decrease in efficiency).

Even after the slight decrease in the absorptive component's efficiency, the absorptive component would still be effective enough to control the low frequency resonant behaviour to internationally prescribed standards. So, the trade-off of decreased efficiency of absorption component, for the highly desired naturalization of the room brought about by the plate members (160) that serve as “psychoacoustic localization waypoints”, is one where the benefits outweigh the shortcomings. The resulting pattern of plate members (160), their sizing and their spacing between each other is defined as percentages which are related to the length of the inner shell's dimension in question.

Working of the reflection component (150): A matrix of 36 plate member positions has been devised after analysing locations of modal peak (pressure maxima, antinodes) points and modal null points (pressure minima, nodes). The plate positions are configured such that they are in the positions of minimal pressure and maximum velocity to not impede the functioning the efficiency of the absorbing component as much as possible. The resulting sequence creates a matrix can be applied to all six boundaries of a space. The sequence is (from one end to the other of 1 dimension.): Gap (6.5%), Plate (9.5%), Gap (10.5%), Plate (4.9%), Gap (10.0%), Plate (5.2%), Gap (6.8%), Plate (5.2%), Gap (10.0%), Plate (4.9%), Gap (10.5%), Plate (9.5%), Gap (6.5%). Please note that the values of the gap and plate member discussed above are exemplary. The gap and plate member values can be at a range of Gap (4.7%-6.5%), Plate (9.5%-10%), Gap (10.5%-12%), Plate (4.87%-5.3%), Gap (9.4%-10.0%), Plate (5.2%-5.5%), Gap (6.0%-7.2%), Plate (5.2%-5.5%), Gap (9.4%-10.0%), Plate (4.87%-5.3%), Gap (10.5%-12%), Plate (9.5%-10%), Gap (4.7%-6.5%).

| | | | | | | | | | | | | | |
|---|---|---|---|---|---|---|---|---|---|---|---|---|---|
| Sizes | 6.5% | 9.5% | 10.5% | 4.9% | 10.0% | 5.2% | 6.8% | 5.2% | 10.0% | 4.9% | 10.5% | 9.5% | 6.5% |

| | | | | | | |
|---|---|---|---|---|---|---|
| 6.5% | | | | | | |
| 9.5% | Plate | Plate | Plate | Plate | Plate | Plate |
| 10.5% | | | | | | |
| 4.9% | Plate | Place | Plate | Plate | Plate | Plate |
| 10.0% | | | | | | |
| 5.2% | Plate | Plate | Plate | Plate | Plate | Plate |
| 6.8% | | | | | | |
| 5.2% | Plate | Plate | Plate | Plat | Plate | Plate |
| 10.0% | | | | | | |
| 4.9% | Plate | Plate | Plate | Plate | Plate | Plate |
| 10.5% | | | | | | |
| 9.5% | Plate | Plate | Plate | Plate | Plate | Plate |
| 6.5% | | | | | | |

Thus, the reflection component (150) in an exemplary embodiment of up to 36×6 boundaries (4 walls, ceiling floor) require 216 plate members which serve as psychoacoustic localization waypoints to naturalize the auditory experience of the room. In some circumstances floor modifications may require that some plate members be removed or modified.

The gap between the outer non-porous rigid wall member (120) and the inner porous but resistive wall member (130) must create a sufficiently large volume between the walls (120 and 130) that allows for the pressure differential created on the inner side of the porous but resistive membrane to push a sufficient volume of air through to the other side. As air is pushed through, pressure reduces until equalized, so does the modal influences, with assistance in attenuation by the thermal losses when propagating though the resistive material, and the degree of attenuation is designed such that lowest modal fundamental resonant frequencies to effectively attenuated to within the internationally set standards.

Further, to create the most amount of floor space inside the inner room, which is desirable, (the room within the inner shell consisting of the porous but resistive membrane), this gap can be equated to at least between 35% to 82% of the distance from the outer rigid wall member (120) to the 1st PEAK/ANTINODE of that multiple of the axial mode's fundamental frequency that crosses the Schroeder frequency along that dimension of the room's boundary.

This ensures that all modal influences of the fundamental and its multiples share a strong influence of their pressure component acting on the porous but resistive membrane in that position.

The efficiency of the system is also influenced by the low frequency response of the full spectrum speaker system, and the quality of the isolation of the outer non-porous rigid wall. Full range speaker systems are those that can produce all frequencies across the spectrum of hearing (at least 20-20000 Hz). They can vary from “near field”, “mid field” and “far field” depending on the size of the room they are employed in and the distance at which the listener is seated (far field systems are larger and produce more frequencies in the lower frequency spectrum (sub bass), than mid field, and mid field than near field). It is non-ideal to have very large monitors in smaller rooms as the listener position may be too near and may not be situated at the “sweet spot” of the speaker systems reproduction of sound, but these scenarios do exist.

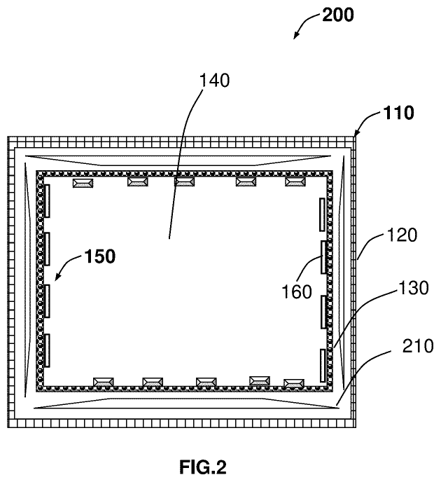

The additional bass loading on the room can increase the intensity of the resonances of the, and although the efficiency of the system (100) would still be enough to attenuate low frequency response effectively, greater low frequency attenuation in the sub bass (below 60 Hz) frequency region for unique cases of monitoring systems with increased low frequency reproduction can be achieved by introducing a middle non-porous rigid wall member (210) with gaps in the bicorners, as shown in FIG. 2.

This variation in the design allows for the boundary surface to create the resonant pressure (non-porous middle wall), which the porous-but-resistive membrane innermost porous wall takes advantage off and allows air flow through it till pressure is equalized, and the gap volume to be maximised by the middle wall's gaps-in-the-corners increasing the entire volume of the air space behind the innermost porous-but resistive membrane shell. It is important to note that the operative gap size as defined earlier, is in this circumstance measured from the middle rigid non-porous wall member to the inner porous-but resistive wall member. The gap size between the middle and outer walls could be variable according to design needs.

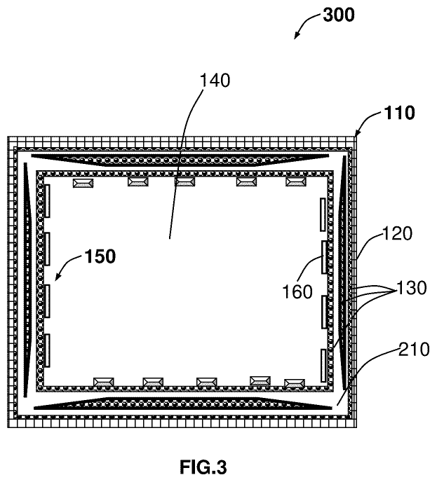

In an alternative embodiment of the present invention, as shown in FIG. 3, the absorption component (110) comprising of an outer non-porous rigid wall member (120) that is configured with a layer of resistive member (130) and an inner porous but resistive wall member (130) with a gap between the outer non-porous rigid wall member (120) and the inner porous but resistive wall member (130) which helps in effective absorption of low frequency range in a sound within the room/environment (140).

The additional bass loading on the room can increase the intensity of the resonances of the, and although the efficiency of the system (100) would still be enough to attenuate low frequency response effectively, greater low frequency attenuation in the sub bass (below 60 Hz) frequency region for unique cases of monitoring systems with increased low frequency reproduction can be achieved by introducing a middle non-porous rigid wall member (210) that is configured with a porous member (130) with gaps in the bicorners, as shown in FIG. 3.

Working of the Invention: Another important criterion of the absorption component (110) is the physical attributes of the porous but resistive membrane, that has 3 critical factors related to the efficiency of the system (100) in its ability to attenuate low frequency effectively. They are the gas flow resistivity of the absorptive element, its thickness and permeability at its surface.

Gas flow resistivity range=15,000 to 25,000 N-s/m4 (20,000 N-s/m4 is a suitable value for effective and efficient low frequency attenuation to achieve internationally prescribed standards for precision listening rooms and control rooms).

The thickness of the porous but resistive membrane consists of an appropriate thickness (e.g., 3-5 inches) and should be selected to ensure it remains in a region of pressure to perform efficiently, while satisfying the gap size and thickness necessary for efficient low frequency absorption. This balance of gap size and thickness becomes more challenging the smaller the room becomes to a point at which a trade-off may have to be struck and the most efficiency of LF attenuation possible be settled for). 3-inch thickness should be suitable for efficiency enough to achieve internationally prescribed standards for rooms under 2500 cu. ft and larger than 3 inch may be considered for larger rooms.

The Air Permeability range of the Aesthetic covering fabric is 1,100 to 1,450 mm/see (Sample size=20 sq. cm, Test pressure=100 Pa, ISO 9237:1995 (E) this range serves to slightly increase the efficiency of resistive membrane system favourably. A higher permeability would not decrease or aid the efficiency of the resistive membrane, but a lower permeability would hinder the air flow and decrease the efficiency, or exceptional cases of smaller rooms with severe modal problems.

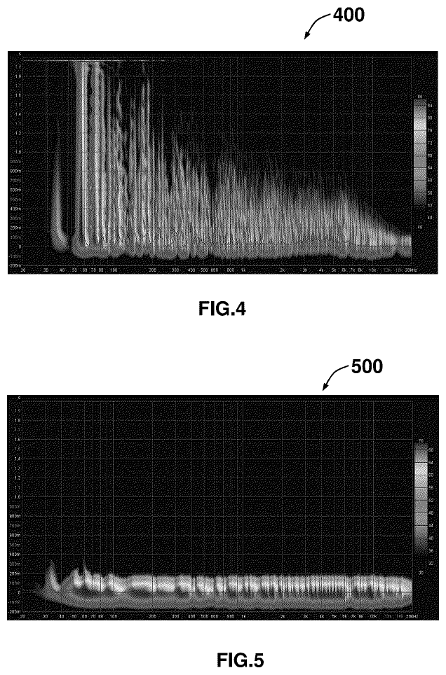

Results: The FIGS. 4-7 demonstrates the GUIs of the measured frequencies of an acoustic room to prove the working of the invention. FIG. 4 illustrates the Spectogram of an acoustic room when empty which clearly shows long decays.

The RT60 (Reverberation time) values of the Absorptive Component of the SYSTEM are tabulated below:

| | | | | | | Sabines |
|---|---|---|---|---|---|---|
| | | | | | | Absorbed by |
| | | Reverb | | | | solely |
| | | Time of | | | Sabines | SYSTEM |
| | | Empty | | Reverb Time of | Absorbed by | consisting of |
| | | room | | Room with | Room with | only the |
| | | [15.75 ft × | | SYSTEM | SYSTEM | Absorption |
| | | 13.83 ft × | Sabines | consisting of | consisting of | Component |
| | | 10.1 ft] | Absorbed | only the | only the | (excluding |
| | | (2200 cuft | by empty | Absorption | Absorption | absorption by |
| Sl no | Frequency Hz | volume} s | room 1 | Component | Component | Room) |
| 1 | 50 | 4.625 | 23.31 | 0.224 | 490.00 | 466.69 |
| 2 | 63 | 4.715 | 22.86 | 0.155 | 708.13 | 685.27 |
| 3 | 80 | 5.618 | 19.19 | 0.181 | 606.41 | 587.22 |
| 4 | 100 | 3.451 | 31.24 | 0.154 | 712.73 | 681.49 |
| 5 | 125 | 3.716 | 29.01 | 0.099 | 1108.69 | 1079.68 |
| 6 | 160 | 3.98 | 27.09 | 0.047 | 2335.32 | 2308.23 |
| 7 | 200 | 3.826 | 28.18 | 0.07 | 1568.00 | 1539.82 |
| 8 | 250 | 2.912 | 37.02 | 0.038 | 2888.42 | 2851.40 |
| 9 | 315 | 2.924 | 36.87 | 0.04 | 2744.00 | 2707.13 |
| 10 | 400 | 3.013 | 35.78 | 0.082 | 1338.54 | 1302.76 |
| 11 | 500 | 2.626 | 41.05 | 0.048 | 2286.67 | 2245.62 |

FIG. 5 illustrates the Spectogram of Absorptive Component in the acoustic room (100) showing full spectrum absorption and effective modal suppression from that of the empty room, as seen FIG. 4.

The RT60 values of the Absorptive and Reflective Component of the acoustic room (100) are tabulated below:

| | | | | | | Sabines |
|---|---|---|---|---|---|---|
| | | | | | | Absorbed |
| | | Reverb | | Reverb | Sabines | by solely |
| | | Time of | | Time of | Absorbed | SYSTEM |
| | | Empty | | Room with | by Room | consisting of |
| | | room | | SYSTEM | with | Absorption |
| | | [15.75 ft × | | consisting | SYSTEM | and |
| | | 13.83 ft × | | of | consisting of | Reflection |
| | | 10.1 ft] | Sabines | Absorption | Absorption | Component |
| | | {2200 | Absorbed | and | and | (excluding |
| | Frequency | cuft | by empty | Reflection | Reflection | absorption |
| Sl no | Hz | volume} | room 1 | Component | Component | by Room) |
| 1 | 50 | 4.625 | 23.31 | 0.24 | 457.33 | 434.03 |
| 2 | 63 | 4.715 | 22.86 | 0.131 | 837.86 | 815.00 |
| 3 | 80 | 5.618 | 19.19 | 0.164 | 669.27 | 650.08 |
| 4 | 100 | 3.451 | 31.24 | 0.135 | 813.04 | 781.80 |
| 5 | 125 | 3.716 | 29.01 | 0.102 | 1076.08 | 1047.07 |
| 6 | 160 | 3.98 | 27.09 | 0.046 | 2386.09 | 2359.00 |
| 7 | 200 | 3.826 | 28.18 | 0.072 | 1524.44 | 1496.27 |
| 8 | 250 | 2.912 | 37.02 | 0.039 | 2814.36 | 2777.34 |
| 9 | 315 | 2.924 | 36.87 | 0.049 | 2240.00 | 2203.13 |
| 10 | 400 | 3.013 | 35.78 | 0.075 | 1463.47 | 1427.69 |
| 11 | 500 | 2.626 | 41.05 | 0.044 | 2494.55 | 2453.49 |

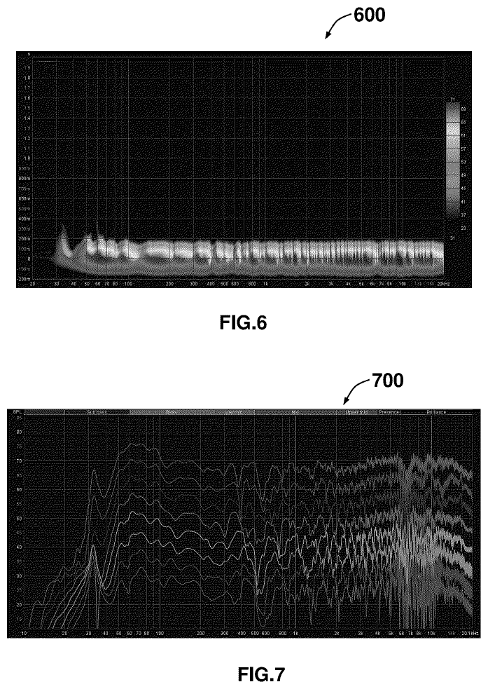

Similarly, FIG. 6 illustrates the Spectogram of the Absorptive and Reflective Components in the acoustic room (200), continues to show full spectrum absorption and effective modal suppression.

The Reflection Component of the system (200) introduces desirable reflections to the environment and does not impede the low frequency absorption and modal suppression of created by the Absorption Component.

FIG. 7 illustrates a GUI showing the consistency of speaker response (Right speaker and Subwoofer) across 8 microphone positions spanning 4.67 feet by the Absorptive and Reflective Components of the system (200).

In the case of rooms that present greater acoustical challenges towards low frequency modal control (such as smaller rooms—<50 m3, or rooms with irregularities in their shape, or with dimensions in ratios that make for problematic modal behaviour, or a combination of these), a second layer or porous but resistive membrane can be introduced into the system, starting from the position that is flush with the outer rigid wall (on the inner side, that faces the inner porous-but-resistive membrane), as shown in FIG. 3. This serves as additional element to the system that brings about further conversion of sound energy into thermal energy when the air molecules are pushed through the interconnected microporous nature of the resistive membrane. Thus, additional thermal and viscous losses occur via dissipation on account of the friction of the air molecules being pushed through the interconnected pores of the resistive-but-porous membrane, as the air moves through the primary inner porous-resistive membrane during the pressure equalization process. Flow resistivity and thickness of this second porous-resistive membrane are an important factor to the efficiency of the system.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

I claim:

1. An acoustic room with absorption and reflection balancing system, comprising:
an absorption component to absorb of the low frequency range in a sound within the room/environment; and
a reflection component that serves as “psychoacoustic localization waypoints” and add reflections that naturalize the environment to the auditory system wherein the absorption component comprising of an outer non-porous rigid wall member and an inner porous but resistive wall member with a gap between the outer non-porous rigid wall member and the inner porous but resistive wall member which helps in effective absorption of low frequency range in a sound within the room/environment.

2. The room as claimed in claim 1 wherein the reflection component comprising an array of plate members that are operatively configured within the inner wall portion of the inner porous but resistive wall member wherein the plate members serve as “psychoacoustic localization waypoints” and add reflections that naturalize the environment to the auditory system.

3. The room as claimed in claim 1 wherein the reflection component is modified by modifying the plate member as diffusive elements, scattering elements, or even porous absorber-based elements.

4. The room as claimed in claim 1 wherein the gap between the outer non-porous rigid wall member and the inner porous but resistive wall member creates a sufficiently large volume between the walls that allows for the pressure differential created on the inner side of the porous but resistive membrane to push a sufficient volume of air through to the other side; to create the most amount of floor space inside the inner room, the gap can be equated to at least between 35% to 82% of the distance from the outer rigid wall member to the 1st PEAK/ANTINODE of that multiple of the axial mode's fundamental frequency that crosses the Schroeder frequency along that dimension of the room's boundary.

5. The room as claimed in claim 1 wherein a middle non-porous rigid wall with gaps in the bicorners which allows for the boundary surface to create the resonant pressure, which the porous-but-resistive membrane innermost porous wall takes advantage off and allows air flow through it till pressure is equalized, and the gap volume to be maximised by the middle wall's gaps-in-the-corners increasing the entire volume of the air space behind the innermost porous-but resistive membrane shell.

6. The room as claimed in claim 1 wherein the absorption component comprising of an outer non-porous rigid wall member that is configured with a layer of resistive member and an inner porous but resistive wall member with a gap between the outer non-porous rigid wall member and the inner porous but resistive wall member which helps in effective absorption of low frequency range in a sound within the room/environment.

7. The room as claimed in claim 6 wherein the additional bass loading on the room can increase the intensity of the resonances, and although the efficiency of the system would still be enough to attenuate low frequency response effectively, greater low frequency attenuation in the sub bass frequency region for unique cases of monitoring systems with increased low frequency reproduction can be achieved by introducing a middle non-porous rigid wall member that is configured with a porous member with gaps in the bicorners.

8. An acoustic room including an absorption and reflection balancing system utilizing diffusion and scattering characteristics comprising:
an absorption component being shaped, oriented and dimensioned to absorb sound within the room at low frequency ranges, having an outer non-porous rigid wall member and an inner auditory porous but resistive wall member defining a gap therebetween; and
a reflection component shaped, oriented and dimensioned to enable reflections that naturalize the sound in the room to the auditory system
wherein the absorption component helps in effective absorption of low frequency range in a sound within the room.

9. The room as claimed in claim 8 wherein the absorption component further comprises a combination of an outer non-porous rigid wall member that is configured with a layer of resistive material and an inner porous but resistive wall member with a gap between the outer non-porous rigid wall member and the inner porous but resistive wall member, the combination having dimensions and orientation to provide for effective absorption of a low frequency sound range within room.

10. The room as claimed in claim 9 wherein the additional bass loading on the room can increase the intensity of those resonances while maintaining enough absorption to attenuate low frequency response effectively, and providing for greater low frequency attenuation in the sub bass frequency region (below 60 Hz).

11. The room as claimed in claim 10 further comprising a middle non-porous rigid wall member configured with a porous member with gaps in the bicorners to provide for monitoring systems when encountering increased low frequency reproduction.
